(19) United States
(12) Patent Application Publication
(10) Pub. No.: US 2026/0109590 A1
(43) Pub. Date: Apr. 23, 2026

(54) FITTING COMPRISING A DATA CARRIER FOR A BEVERAGE KEG

(71) Applicants: DSI MICRO MATIC GMBH, Hamm (DE); VINSERVICE MICRO MATIC S.R.L., Zanica (BG) (IT)

(72) Inventors: Mirco WOLTER, Welver (DE); Philipp SOMMER, Eickelborn (DE); Stefan SUELTROP, Erwitte (DE)

(21) Appl. No.: 19/109,559

(22) PCT Filed: Sep. 4, 2023
(86) PCT No.: PCT/DE2023/100641

§ 371 Date: Mar. 7, 2025

(30) Foreign Application Priority Data
Sep. 8, 2022 (DE) 10 2022 122 873.8

(51) Int. Cl. B67D 1/08

(52) U.S. Cl. CPC B67D 1/0888; B67D 1/0841; B67D 1/0835

(57) ABSTRACT

A fitting assembly for a beverage keg, the fitting assembly including a fitting housing having a resilient riser pipe that is located therein and is movable relative thereto; and a seal, wherein an electronic data carrier is located on or in the seal and/or in a cover for the seal.

### RELATED APPLICATIONS

The present application is a National Phase of International Application Number PCT/DE2023/100641, filed Sep. 4, 2023, and claims priority of German Application Number 10 2022 122 873.8 filed Sep. 8, 2022.

### FIELD

The present disclosure relates to a fitting assembly for a beverage keg.

### BACKGROUND

Beverages for consumption are able to be stored in containers. This enables transportation from the beverage production facility, for example a brewery, to the place of consumption, for example a restaurant.

Containers for beverages are bottles, cans, and beverage kegs. In the latter case, larger quantities of the respective beverage, for example more than 10 liters, more than 20 liters, or more than 30 liters of the beverage are able to be stored in a beverage keg.

In order to fill the beverage into the beverage keg at the filling location and extract at the beverage the removal location, the beverage is able to be tapped from the beverage keg under pressure with the aid of a gas. CO2 is used for this purpose. The beverage kegs have a keg body with an outer shell for this purpose. The keg body is able to be made of a metallic material. The keg body has an opening in the middle of its upper side, into which a fitting is inserted. The fitting serves as a coupling point for filling the keg. Once the filling process is complete, the fitting remains on the keg and has a seal or sealing assembly so that the beverage filled into the keg remains sealed and, if necessary, under pressure.

At the tapping point, the beverage keg is connected to a dispensing system. On the one hand, there is a gas line for introducing the gas into the beverage keg and a beverage line for tapping or extracting the beverage from the keg. A keg coupler is used for this purpose, which is connected to the fitting, for example, in a form-fitting and fluid-tight, but releasably coupled manner.

Since the keg body itself is made of a metallic, i.e. non-transparent and opaque material, and the kegs are often cleaned after initial filling and refilled many dozens of times, being able to obtain information about the respective keg contents is desirable and, if necessary, further information about the keg and/or the fitting. This is due to the reuse of the fitting, external markings, for example with stickers, labels or even permanent markings, for example by engraving using a laser, are only suitable to a limited extent.

A riser pipe is described from GB 2 383 990 A, into which a transponder is cast by means of a sealing compound, for example, rubber material.

### SUMMARY

The object of the present disclosure is therefore to provide a beverage keg, wherein information on the beverage keg and optionally on the beverage remains on the beverage keg in a rewritable and fixed manner.

The aforementioned object is achieved according to the present disclosure with a fitting assembly.

The fitting assembly for a beverage keg has a fitting sleeve with a resiliently and, depending on the embodiment, sometimes also relatively movable riser pipe arranged therein, as well as a seal. The fitting assembly, for example, the sleeve and the riser pipe, are made of metallic material, for example, food-grade material, for example stainless steel. The seal is located between the fitting housing, for example, on the inner lateral surface of the fitting housing and the riser pipe, and thus seals the riser pipe against the fitting housing.

According to the present disclosure, the fitting assembly is characterized in that an electronic data carrier is arranged on or in the seal or a cover located above the seal. The data carrier is, for example, an RFID tag or an NFC tag. This makes possible to store information on the electronic data carrier, which contains the following data, individually or cumulatively, but not exhaustively:
Age of the seal and/or the fitting
Information on the keg, age and/or fitting replacements and/or fillings of the keg.
The filling capacity of the keg is also able to be stored. In at least one embodiment of the present disclosure, however, the age, type or brand and/or filling location of the keg contents, i.e., the beverage contained in the keg, are respectively recorded.
Information relating to the keg pressure, for example, is also able to be indicated. With coupled additional sensors, information about temperature, keg pressure and/or the transportation of the keg and the beverage content contained there is able to be stored or evaluated.
Best-before date of the beverage
Designation/name of the beverage
Brewery/manufacturer.

The data carrier itself is, for example, designed to be energy-free, thus, has no active energy source.

The data carrier itself is rewritable. In at least one embodiment of the present disclosure, the data carrier is able to have code protection or password protection. This means that writing data to the data carrier is only possible with special technical aids and authentication. This prevents misuse or incorrect overwriting.

The fitting assembly is suitable for reading with corresponding readout hardware. This could be a smartphone with the corresponding software or app, so that the respective keg is able to be randomly checked for content, filling date, type of beverage, etc. during the delivery of beverage kegs to a handling point of a wholesaler or also at a delivery point of an event or a restaurant. The kegs are also able to be detected at least partially or fully automatically at the breweries or transfer points. This means that information such as the number of times the keg has been rinsed or the dates and contents of the filling process are stored. And the manufacturer is able to integrate the writing on the tag fully automatically in his filling line or at a downstream point in the process chain.

However, the fitting assembly is particularly suitable in conjunction with a sensor system in a keg coupler. This provides in the case of a connected keg, for example for the pub owner or a higher-level brewery, to identify where a keg with the filled beverage is being dispensed or is connected to a dispensing system.

In order for the electronic data carrier to be integrated in accordance with the present disclosure, the data carrier is arranged either in the seal, for example, in an upper region of the seal in the vertical direction or towards the keg coupler, or that the data carrier is arranged on the seal. If the data carrier is arranged on the seal, a cover is arranged over the data carrier. The data carrier is able to be self-adhesive and thus be arranged on the seal or the cover. The seal is made of a rubber-like material, for example, an elastomeric material. The cover is made of a non-electronically shielding material, for example a plastic material. This allows for the data on the data carrier read or write to the data carrier wirelessly, despite the fact that the data carrier itself has no active energy source. As an alternative to the arrangement on the upper side of the seal, the data carrier is also able to be arranged on the underside of the seal, for example, by being connected to the seal by an additive (so-called bonding).

Since the data carrier is either arranged in the upper region of the seal or is covered by a cover, the data carrier is not in direct contact with the beverage or cleaning media. This also means that the data carrier is not exposed to abrasive wear or direct mechanical contact when filling or tapping a keg coupler. This allows for the data carrier to have a long service life, corresponding to the product life of the seal or fitting, during which the data carrier is readable or also rewritable.

To manufacture the data carrier, for which food-grade material is able to be used, an RFID tag or NFC tag, is able to provide electronic conductor tracks on a plastic film or a dimensionally stable material such as a plastic ring or a PCB (so-called FR-4 glass fiber composite material) and then cast the data carrier into the seal or cast the cover onto the seal or attach the data carrier to the seal cover. This process is called overmolding. During the overmolding process, the printed circuit board or the conductor foil of the data carrier is able to melt at least partially to completely. Since the seal or the cover is electrically non-conductive, the conductor tracks of the data carrier are electrically insulated from each other, for example, from direct contact, so that the functions are retained after the seal has been produced or a cover has been applied to the seal. The data carrier according to the present disclosure is able to have a construction height of less than 0.5 mm.

In at least one embodiment of the present disclosure, the data carrier is able to be mounted on a dimensionally stable ring carrier and then attach to the underside of the seal cover using epoxy resin. This creates a chemical/force-fitting connection which is suitable for use with food applications without gaps or other irregularities. Even if the assembly is outside the keg, the use of bonding material approved for food contact is recommended. The same connection is configured to withstand the thermal, chemical and mechanical stresses of a keg's life cycle. And the installation space taken up by the data carrier and bonding material is able to be compensated for by optimizing the design of the elastomer seal so that the assembly of seal and data carrier, including TAG, is 1:1 interchangeable with the seal and carrier assembly as before and available on the market.

For other embodiment variants of fittings (for example of the A-and G-type: FIG. 8), the arrangement of the data carrier in the main seal is expedient. This means that the data carrier is also able to be integrated into the overall product by replacing the seal in fittings already on the market. The integration is able to be carried out during the manufacturing process of the seal by inserting the data carrier into the manufacturing tool of the seal in such a way that the data carrier is inserted/held in the tool and overmolded with elastomer. Alternatively, the data carrier is attached in/to the seal after the seal manufacturing process or subsequently inserted into the upper side of the seal in a separate carrier part or arranged on the underside of the seal.

### BRIEF DESCRIPTION OF THE DRAWINGS

Further advantages, features, properties and aspects of the present disclosure are the subject of the following description. Variant embodiments are the subject of the following description. These serve to facilitate understanding of the present disclosure. In:

FIG. 1 shows a fitting assembly in cross-sectional view according to the present disclosure,

FIG. 2 shows a fitting assembly in cross-section with data carrier in the separating plane between carrier and seal according to the present disclosure,

FIG. 3 shows an exploded view of FIG. 2 with the housing 2 in cross section according to the present disclosure,

FIG. 4 shows a cross-sectional view with the data carrier cast into the seal according to the present disclosure,

FIG. 5 shows a data carrier cast into the cover according to the present disclosure,

FIG. 6 shows a U-type fitting assembly with the tag applied to the seal carrier according to the present disclosure,

FIG. 7 shows a D-type fitting assembly with the tag applied to the seal carrier according to the present disclosure, and

FIG. 8 to FIG. 11 show various cross-sectional views of an A-type fitting assembly according to the present disclosure.

### DETAILED DESCRIPTION

The same reference numerals are used in the figures for identical or similar components, although a repeated description is omitted for reasons of simplification.

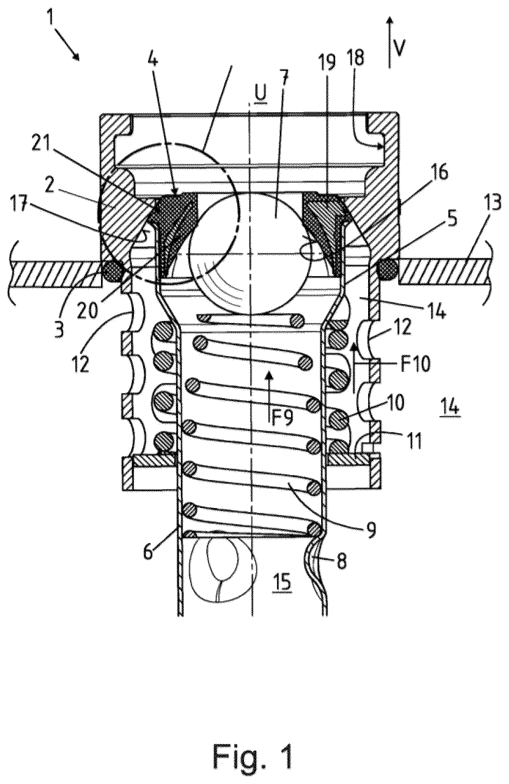

FIG. 1 shows the fitting assembly 1 in a cross-sectional view. A fitting housing 2 has an outer sealing ring 3 to be arranged in a fluid-tight manner in a beverage keg 13, which is not shown in detail. The seal 4 is arranged in the fitting housing 2, which seal is inserted into an upper end 5 of a riser pipe 6 in a form-fitting, fluid-tight manner. For this purpose, a sealing body in the form of a ball 7 with a helical compression spring 9 is inserted so that the ball 7 is brought into form-fitting contact with an inner sealing surface of the seal 4 against a spring force. For this purpose, bulges 8 are formed in the riser pipe 6, which bulges hold the helical compression spring 9 form-fittingly in the riser pipe 6. Furthermore, a helical compression spring 10 surrounding the riser pipe 6 and a retaining ring 11 are arranged, which press the entire riser pipe 6 into the fitting housing 2 from the inside. Furthermore, the fitting housing 2 has recesses 12 in its lateral surface. Furthermore, the seal 4 is arranged between the fitting housing 2, here on the inside of the fitting housing 2 at a sealing surface 17, and the riser pipe 6. The seal 4 thus seals the fitting housing 2 against the riser pipe 6. The riser pipe 6 is able to be arranged in the fitting housing 2 so as to be movable relative thereto. However, the riser pipe 6 is also able to be fixed in the fitting housing 2, in which case a further valve body is mounted in the riser pipe 6.

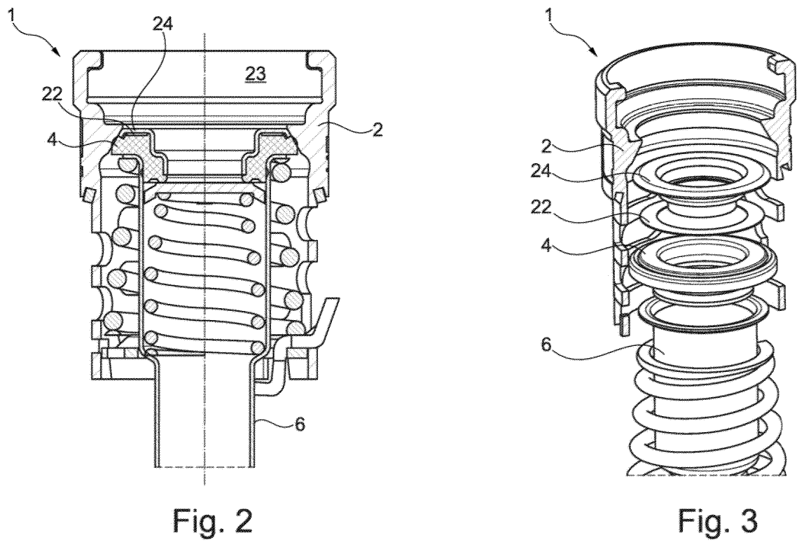

FIG. 2 shows a cross-sectional view of an assembled fitting assembly 1, wherein the fitting assembly 1 is inserted into a beverage keg 13. For this purpose, a gas side 14 is formed in the beverage keg 13 itself and a beverage side 15 is formed in the riser pipe 6 itself and below the fitting assembly 1, provided that the beverage keg 13 is oriented upwards in relation to the vertical direction V. In at least one embodiment of the present disclosure, the gas side 14 is formed between the fitting housing 2 and the riser pipe 6, which is realized by the recesses 12 in the fitting housing 2. In the closed sealing state, the spring force F9 thus presses the ball 7 against an inner sealing surface 16 of the seal 4. Any beverage present on the beverage side 15 is thus prevented from escaping into the environment U.

The upper end 5 of the riser pipe 6 is widened, wherein the second helical compression spring 10 comes into form-fitting contact here and presses the entire riser pipe 6 with the seal 4 against an internal sealing surface 17 of the fitting housing 2 against a spring force F10. This also seals the beverage from the gas side 14 against the environment U in the closed state.

In the event of activation, a keg coupler not shown in detail would be inserted form-fittingly into a keg coupler receptacle 18 and press the riser pipe 6 with seal 4 downwards in relation to the vertical direction V. This would transport a gas into the beverage keg 13 via the gas side 14, so that when the keg coupler is connected, the ball 7 or sealing plate is in turn also moved downwards relative to the seal 4 in the vertical direction V, allowing the beverage to flow out and be removed from the beverage keg 13.

The seal 4 itself is made of a reinforcing ring 19 and an elastic sealing material 20 surrounding the seal 4. The seal 4 has an upper head section K and a web section S.

This is an S-type fitting. A data carrier 22 is arranged on the seal 4, on the upper side of the seal 4. This electronic data carrier 22 is arranged in the form of a circular ring or circular ring section once around the seal 4 or on the seal 4. A cover 24 is arranged above the seal 4 in the direction of a possible outlet 23 of the fitting assembly 1, which cover at least partially overlaps the seal 4. The cover 24 also covers the electronic data carrier 22 so that the electronic data carrier 22 does not come into contact with the liquid or beverage in the keg 13. To produce the seal 4 with cover 24, the data carrier 22 is positioned on the material of the seal 4 or the material of the cover 24 and the two components are then plugged together. In at least one embodiment of the present disclosure, the cover 24 is able to be injected or cast made of a plastic-like material onto the seal 4, for example, in the form of an overmolding process. The data carrier 22 is thus cast between cover 24 and seal 4 and therefore also sealed. The data carrier 22 is able to then be read through the cover 24 using a corresponding readout device.

FIG. 3 shows an exploded view of FIG. 2. In this case, the data carrier 22 is designed as a circumferential circular ring.

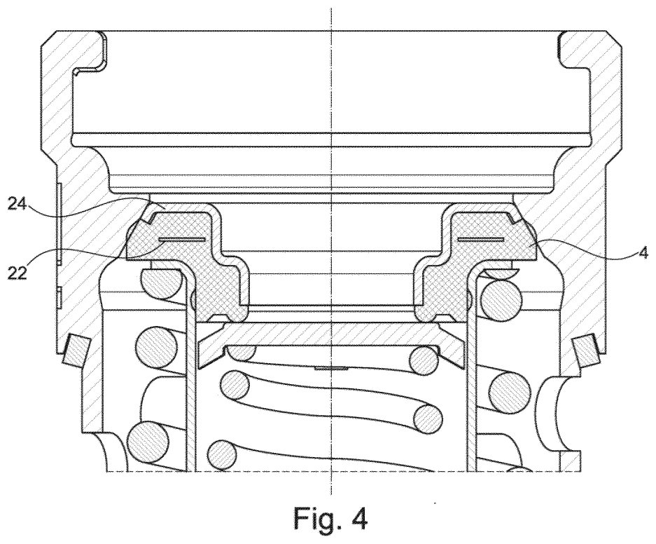

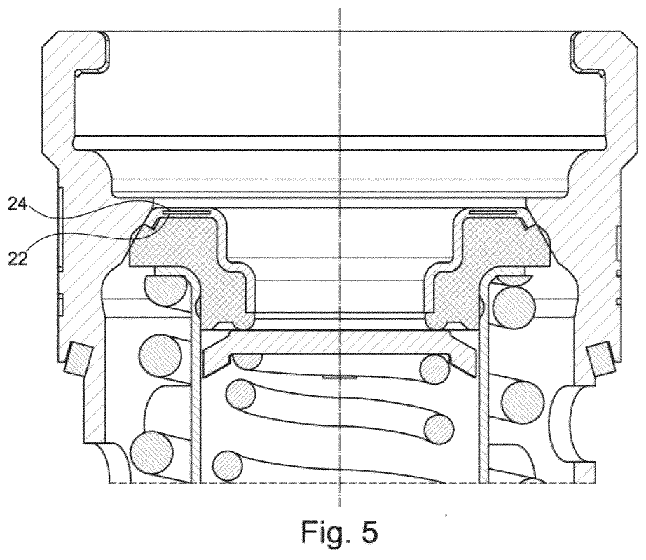

FIG. 4 shows a cross-sectional view, analogous to FIG. 2. In this case, however, the data carrier 22 is cast into the seal 4 itself. The cover 24 is additionally attached to the seal 4. However, the seal 4 is first produced with the data carrier 22. The tag is held or positioned in the tool of the seal 4 and then the seal 4 is molded over in one piece and in one step.

FIG. 5 shows an alternative embodiment. Here, the data carrier 22 is cast into the cover 24. Thus, the data carrier 22 is located on the seal 4, but completely overmolded or cast into the cover 24 itself.

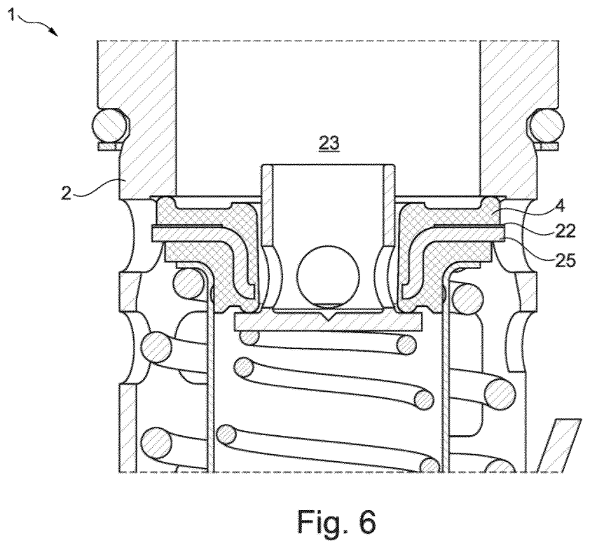

FIG. 6 shows an alternative design variant. A U-type fitting assembly 1 is shown in this case. The data carrier 22 is arranged here on a circumferential ring 25, made of metal or alternatively plastic. The metal ring 25 is at least partially cast into the seal 4. Here too, the data carrier 22 is able to first be arranged on the metal ring 25 or the metal reinforcement of the seal body and then overmolded with the sealing material 20, also in an overmolding process. The data carrier 22 is thus sealed off from the beverage, at least with regard to the outlet 23. The data carrier 22 is able to partially extend laterally beyond the metal ring 25 in order to facilitate positioning in the tool.

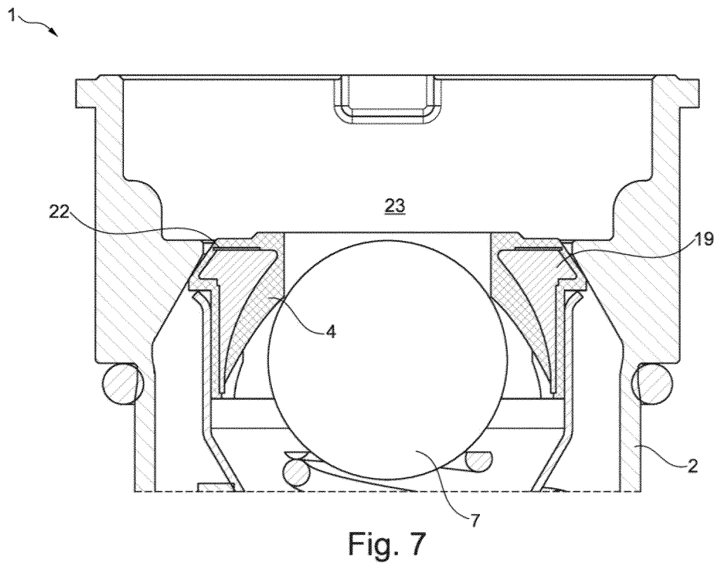

FIG. 7 shows a D-type fitting assembly 1 already described at the beginning in FIG. 1. Here too, a metal reinforcing ring 19 is arranged in the seal 4 itself. Here, the electronic data carrier 22 is applied to a reinforcing ring 19, metallic or made of plastic, but sufficiently dimensionally stable, and then overmolded with the sealing material 20 in the overmolding process, so that here too the data carrier 22 is sealed off from a beverage to be withdrawn.

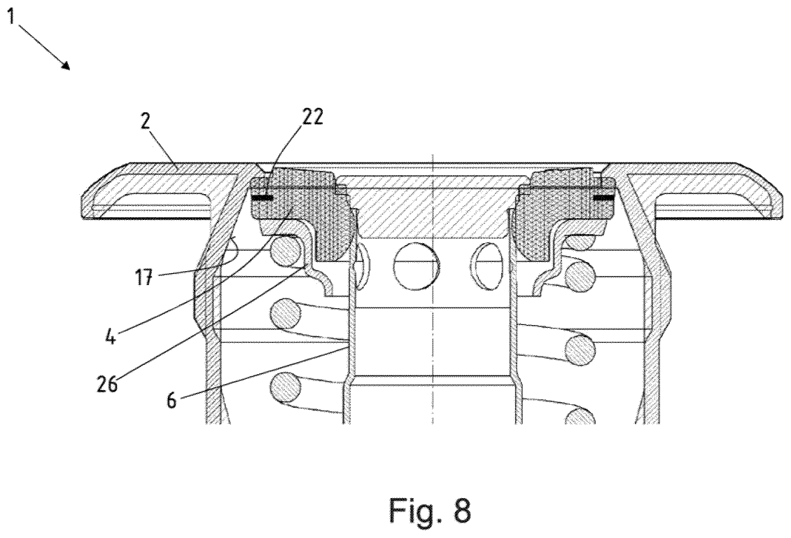

FIG. 8 shows a cross-sectional view of a fitting assembly. The seal 4 is located between the riser pipe 6 and on the inside of the fitting. The data carrier 22 itself is arranged centrally in the seal 4 and has been overmolded with elastomer during manufacture.

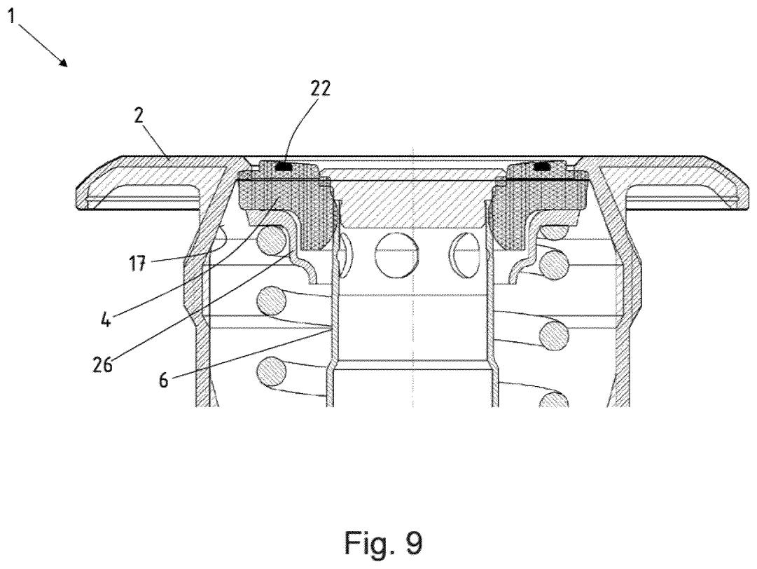

FIG. 9 alternatively shows that the data carrier 22 is inserted into an upper side of the seal 4. For this purpose, the data carrier 22 is also able to be injected directly into the seal 4, but also able to be subsequently inserted into a groove.

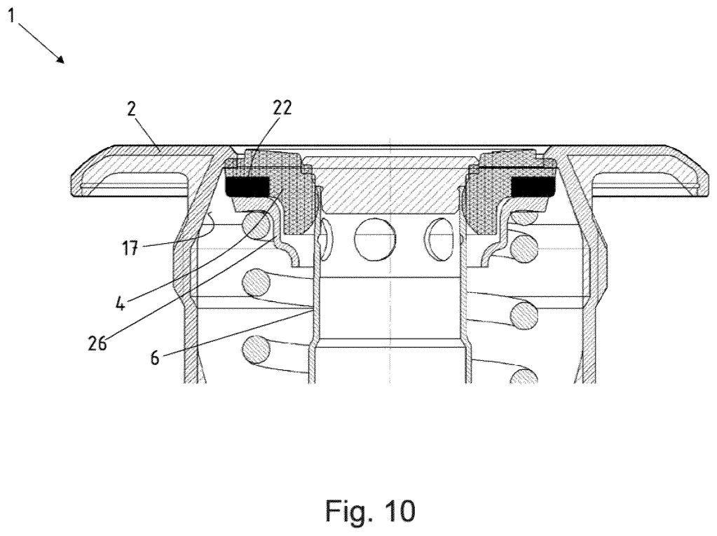

In an alternative embodiment variant according to FIG. 10, the data carrier 22 is arranged below the seal 4 and rests on an upper sleeve 26.

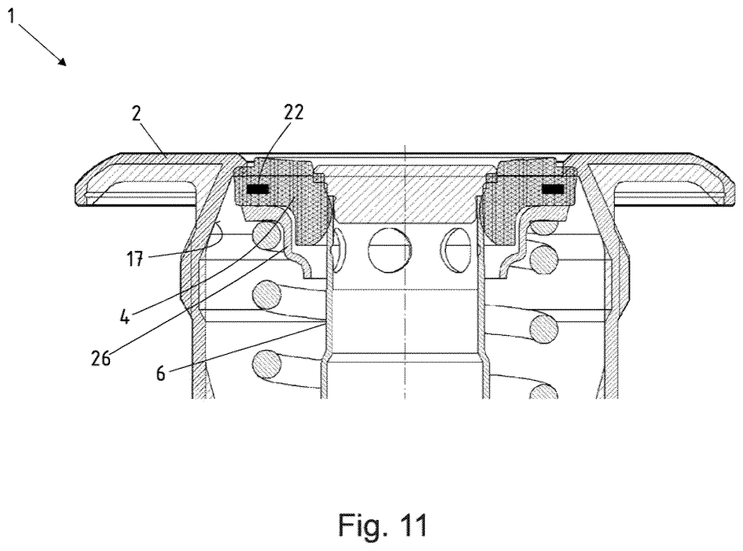

According to FIG. 11, the data carrier 22 is completely integrated into the seal 4, i.e. completely overmolded with the sealing material 20, which is, for example, an elastomer.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-9. (canceled)

10. A fitting assembly for a beverage keg, said fitting assembly comprising:
a fitting housing having a resilient riser pipe arranged therein; and
a seal arranged between the fitting housing and the resilient riser pipe, wherein an electronic data carrier is located at the seal or in a cover of the seal.

11. The fitting assembly according to claim 10, wherein the data carrier is an RFID tag or an NFC tag.

12. The fitting assembly according to claim 10, wherein the data carrier comprises an at least partially encircling circular ring section.

13. The fitting assembly according to claim 10, wherein the data carrier is arranged on the seal, and the data carrier is overlapped by the cover of the seal, the cover comprising a plastic material.

14. The fitting assembly according to claim 10, wherein the data carrier is cast into the seal.

15. The fitting assembly according to claim 10, wherein the data carrier is operable without energy.

16. The fitting assembly according to claim 10, wherein the data carrier has a code protection.

17. The fitting assembly according to claim 10, wherein at least one of the following pieces of information is recorded on the data carrier:
type and age of the seal or of fitting housing,
age or filling capacity of the beverage keg,
age, brand or filling location of beverage in the keg,
unique ID number,
filling quantity of the keg,
best-before date of the beverage in the keg,
designation/name of the beverage,
brewery/manufacturer,
the filling location.

18. The fitting assembly according to claim 10, further comprising: a sealing body, a first spring and a second spring, wherein
the fitting housing has a conical internal sealing surface which tapers towards an upper end of the resilient riser pipe,
the seal is inserted between the conical internal sealing surface and the upper end of the resilient riser pipe,
the resilient riser pipe is pressed against the conical internal sealing surface with the seal due to a first spring force of the first spring,
the seal is arranged on an inside in the upper end of the resilient riser pipe, and
in the upper end of the resilient riser pipe, the sealing body is arranged in a resiliently relatively movable manner such that the sealing body comes to rest in a form-fitting manner against an inner sealing surface of the seal due to a second spring force of the second spring.

19. The fitting assembly according to claim 10, wherein the resilient riser pipe is moveable relative to the fitting assembly.

20. The fitting assembly according to claim 10, wherein the data carrier comprises a fully encircling circular ring section.

21. The fitting assembly according to claim 10, wherein
the data carrier is arranged on the seal, and
the data carrier is overlapped by the cover of the seal, the cover comprising a non-wireless wave-shielding material.

22. The fitting assembly according to claim 10, wherein the data carrier is cast under the cover on the seal.

23. The fitting assembly according to claim 10, wherein the data carrier is cast under the cover.
